(19) United States
(12) Patent Application Publication
(10) Pub. No.: US 2012/0032476 A1
(43) Pub. Date: Feb. 9, 2012

(54) ROOF DEVICE FOR VEHICLE

(76) Inventors: Tetsuya Hirata, Aichi-ken (JP); Chitose Nishiyama, Aichi-ken (JP)

(21) Appl. No.: 12/998,121

(22) PCT Filed: Mar. 16, 2010
(86) PCT No.: PCT/JP2010/054382

§ 371 Date: Mar. 18, 2011

(30) Foreign Application Priority Data
Mar. 27, 2009 (JP) 2009-079181

(51) Int. Cl. B60J 7/02

(52) U.S. Cl. 296/216.04

(57) ABSTRACT

A roof device for a vehicle is disclosed. Guide rails extend in a direction along the front and back of the vehicle on both sides of an opening of a vehicle roof. Operation mechanisms are guided by the corresponding guide rails and support a movable panel. A toothed belt has a plurality of rack teeth arranged in a longitudinal direction of the toothed belt. A drive-side guide section guides movement of the toothed belt. A rail-side guide section guides movement of the toothed belt. A sliding section is formed integrally with each toothed belt. A fitting section is formed in at least each drive-side guide section or each rail-side guide section. The fitting section restricts movement of the rack teeth of each toothed belt toward the corresponding opposite face of the drive-side guide section or rail-side guide section.

### TECHNICAL FIELD

The present invention relates to a roof device for a vehicle.

### BACKGROUND ART

A conventionally known roof device for a vehicle is described in, for example, Patent Document 1. The roof device for a vehicle includes: a pair of guide rails extending in directions along the front and back of the vehicle on both sides in the widthwise direction of the vehicle; a front housing connecting the front ends of the guide rails to each other; and a pair of operation mechanisms supporting a movable panel guided along the guide rails. Additionally, a toothed belt, which is three-dimensionally deformable, is connected to each operation mechanism. A drive gear rotated and driven by a drive source is provided in the middle of the front housing. The toothed belt engages with the drive gear. This toothed belt is movably accommodated in a guide portion (casing pipe) molded in a substantially quadrangular shape corresponding to the outer shape of the toothed belt and locked in the front housing. Therefore, when the toothed belt is moved by rotating and driving the drive gear in order to transmit drive force to an operation mechanism, the movement of the toothed belt is guided by the guide portion and the guide rails, thus transmitting drive force to the operation mechanism.

### PRIOR ART DOCUMENT

### Patent Document

Patent Document 1: Japanese Laid-Open Patent Publication

### SUMMARY OF THE INVENTION

### Problems that the Invention is to Solve

According to Patent Document 1, a step is likely to form due to installation error, for example, at the boundary between the guide portion and the guide rails. If a step is present, the teeth of the toothed belt contacts the step during the movement of the toothed belt, which can produce noise.

Accordingly, it is an objective of the present invention to provide a roof device for a vehicle, which reduces noise and the like resulting from contact between a toothed belt and a guide section.

### Means for Solving the Problems

In order to achieve the foregoing object, a roof device for a vehicle is provided according to the present invention.

A roof device for a vehicle includes a movable panel, a pair of guide rails, operation mechanisms, a drive gear, toothed belts, drive-side guide sections, rail-side guide sections, sliding sections, and a fitting section. The movable panel is capable of opening and closing an opening provided in the vehicle. The guide rails are located on both sides of the opening in a widthwise direction of the vehicle, and are adapted to extend in a direction along the front and back of the vehicle. The operation mechanisms are guided by the corresponding guide rails and support the movable panel. The drive gear is rotated and driven by a drive source. The toothed belt engages with the drive gear and is connected to the corresponding operation mechanism. The toothed belt has a plurality of rack teeth arranged in a longitudinal direction of the toothed belt. The drive-side guide section extends between the drive gear and each guide rail so as to surround the corresponding toothed belt and guides movement of the toothed belt. The rail-side guide section is formed in each guide rail, and extends toward the operation mechanism so as to surround the toothed belt, and guides movement of the toothed belt. The sliding section is formed integrally with each toothed belt. A fitting section is formed in at least each drive-side guide section or each rail-side guide section and slidably fits on the corresponding sliding section. The fitting section restricts movement of the rack teeth of each toothed belt toward the corresponding opposite face of the drive-side guide section or rail-side guide section.

According to the configuration, in the toothed belt, the sliding section fits in the fitting section so as to be slidable. This restricts the rack teeth from movement toward the opposite face of the drive-side guide section or rail-side guide section in which the fitting section is formed. This ensures a required clearance between the rack teeth and the opposite face. Therefore, when the toothed belt enters one of the drive-side guide section and the rail-side guide section from the other, the opposite face and the rack teeth are prevented from contacting each other at the edge end of the drive-side guide section or rail-side guide section. Hence, noise thus resulting can be reduced.

In this case, “to surround the toothed belt” does not means that the drive-side guide section has to be formed so as to cover the toothed belt all around. However, it means that, for example, an opening may be formed in part of a groove.

Preferably, the fitting section may include a drive-side fitting section formed in each drive-side guide section and a rail-side fitting section formed in the rail-side guide section.

According to the configuration, the rack teeth of the toothed belt are restricted from movement toward the opposite faces of the drive-side guide section and rail-side guide section respectively. Thus, a required clearance can be ensured between the rack teeth and the opposite faces of the drive-side guide section and rail-side guide section respectively. Accordingly, even if a step forms between the opposite faces at the boundary between the drive-side guide section and the rail-side guide section due to, for example, variations in manufacture or assembly error, the step is absorbed in the range of the clearance. Accordingly, contact of the rack teeth during the movement of the toothed belt, and hence emission of resulting noise is thus prevented.

Preferably, the end of the drive-side guide section connected to the corresponding rail-side guide section may have an inclined part that gradually increases the clearance between the opposite face and the rack teeth as the inclined part approaches the rail-side guide section.

According to the configuration, the clearance between the opposite face and the rack teeth gradually increases toward the edge end of the drive-side guide section by virtue of the inclined part, and this clearance is defined maximum at this edge end. This makes it possible to more reliably prevent contact between the opposite face and the rack teeth at the edge end when the toothed belt enters the drive-side guide section from the rail-side guide section. Therefore, the toothed belt can smoothly be drawn into the drive-side guide section along the inclined part.

Preferably, the sliding sections are formed on both sides of each toothed belt in a widthwise direction of the toothed belt and extend in the longitudinal direction of the toothed belt. The fitting section may include a first fitting section and second fitting section arranged so as to face the corresponding sliding sections of each toothed belt.

According to the configuration, the sliding sections formed on both sides of the toothed belt in the widthwise direction of the toothed belt fit in the first and second fitting sections. Accordingly, unconstrained by the shape of the opposite face of the drive-side guide section or rail side guide to the rack teeth, the belt can move more stably. Especially, this configuration is applied in the configuration described in claim 3. This also yields the advantage that movement of the toothed belt can be guided by the drive-side guide section regardless of the provision of the inclined part.

### BRIEF DESCRIPTION OF DRAWINGS

FIG. 1 is a plan view of a sun roof device according to one embodiment of the present invention;

FIG. 2 is an enlarged view of a surrounded part indicated by the reference number 2 in FIG. 1;

FIG. 3 is a cross-sectional view taken along the line 3-3 of FIG. 2;

FIG. 4 is a cross-sectional view taken along the line 4-4 of FIG. 2;

FIG. 5 is a cross-sectional view taken along the line 5-5 of FIG. 1;

FIG. 6 is a perspective view of a belt according to the present embodiment;

FIG. 7 is a cross-sectional view taken along the line 7-7 of FIG. 1;

FIG. 8 is a cross-sectional view taken along the line 8-8 of FIG. 7;

FIG. 9 is a cross-sectional view of a belt and guide groove according to a modified embodiment of the present invention; and

FIG. 10 is a cross-sectional view of a belt and guide groove according to another modified embodiment of the present invention.

### BEST MODES FOR CARRYING OUT THE INVENTION

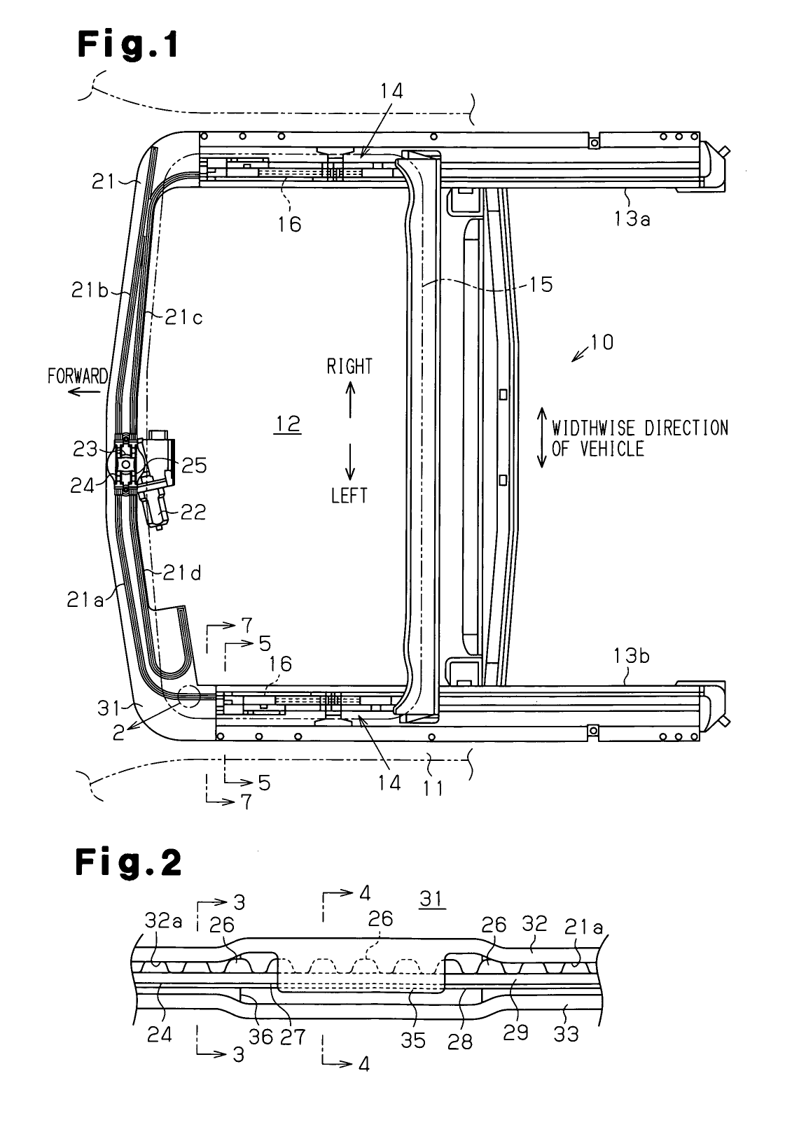

One embodiment according to the present invention will hereinafter be described with reference to FIGS. 1 to 8.

As shown in FIG. 1, a sunroof device 10 is installed in a substantially quadrangular opening 12 formed in a roof 11 of a vehicle. The opening 12 has left and right edges extending in the above-mentioned direction of the vehicle (i.e., in directions along the front and back of the roof 11) on the left and right sides of the vehicle. The sunroof device 10 includes a right guide rail 13a and a left guide rail 13b fixed to the roof 11 so as to extend along the left and right edges of the opening 12. The guide rails 13a and 13b are formed, for example, by extrusion-molding aluminum alloy.

An operation mechanism 14 is supported by each of the guide rails 13a and 13b so as to be movable along the guide rails 13a and 13b. A movable panel 15 made of glass extends between the operation mechanisms 14 so as to be able to close the opening 12. The movable panel 15 is supported and fixed by the operation mechanisms 14. While moving along the guide rails 13a and 13b, the pair of operation mechanisms 14 moves the movable panel 15 by virtue of the shape of the guide rails 13a and 13b and also tilt it upward and downward. The opening 12 is opened or closed, for example, by this movement of the movable panel 15. Specifically, when the opening 12 is opened or closed, the operation mechanisms 14 controls the position of the movable panel 15 in conjunction with the guide rails 13a and 13b.

The sunroof device 10 includes a front housing 21 made of resin, which extends along the width of the vehicle so as to connect the front ends of the guide rails 13a and 13b. In the middle of the front housing 21 in the widthwise direction of the vehicle is an electric motor 22 serving as a drive source. A drive gear 23 formed by a spur gear, which is rotated and driven by the electric motor 22, is supported by the front housing 21 so as to be rotatable around a rotation shaft that extends in the direction of the height of the vehicle.

Formed in the front housing 21 are four guide grooves, which are first to fourth guide grooves 21a to 21d of substantially U-shaped cross section. The first to fourth guide grooves 21a to 21d correspond to drive-side guide sections.

As shown in FIG. 1, the first guide groove 21a extends from the drive gear 23 toward a first side (the left side of the vehicle; downward in FIG. 1) in the widthwise direction of the vehicle. In addition, this first guide groove 21a is curved at the first end (left end) of the front housing 21 toward the back of the vehicle and further extends to a point where the guide groove 21a is in contact with the front end of the left guide rail 13b. In addition, the second guide groove 21b extends from the drive gear 23 to the second end (the right end) of the front housing 21, that is, toward a second side (the right side of the vehicle; upward in FIG. 1) in the widthwise direction of the vehicle. Furthermore, on the inside of the second guide groove 21b (i.e., on the back of the vehicle), the third guide groove 21c extends from the drive gear 23 toward the second side (downward in FIG. 1) in the widthwise direction of the vehicle. In addition, the third guide groove 21c is curved at the second end (at the right end) of the front housing 21 toward the back of the vehicle and further extends to a point where the guide groove 21c is in contact with the front end of the right guide rail 13a. On the inside of the first guide groove 21a (i.e., on the back of the vehicle), the fourth guide groove 21d extends from the drive gear 23 to the first side (i.e., upward in FIG. 1) in the widthwise direction of the vehicle. In addition, the fourth guide groove 21d is folded in a substantially U-shape at the point where the groove 21d abuts on the guide groove 21a. The total length of the first and second guide grooves 21a and 21b is substantially equal to the total length of the third and fourth guide grooves 21c and 21d. Additionally, a rail-side guide groove 16, which serves as a rail-side guide section, is formed in the right guide rail 13a. This guide groove 16 extends in directions along the front and back of the vehicle so as to be continuous with the end of the third guide groove 21c that faces the guide rail 13a. Another rail-side guide groove 16, which serves as a rail-side guide section, is formed in the left guide rail 13b. This guide groove 16 extends in the directions of the front and back of the vehicle so as to be continuous with the first guide groove 21a that faces the guide rail 13b.

A first belt 24 made of, for example, resin or rubber, is accommodated in each of the first and second guide grooves 21a and 21b so as to be movable. Similarly, a second belt 25 identical in shape and material to the first belt 24 is accommodated in each of the third and fourth guide grooves 21c and 21d so as to be movable.

The rack teeth 26 (refer to FIG. 2) of the first belt 24 engage with the drive gear 23 at the front of the drive gear 23 between the first and second guide grooves 21a and 21b. The rack teeth 26 of the second belt 25 engage with the drive gear 23 at the back of the drive gear 23 between the third and fourth guide grooves 21c and 21d. Each of the teeth of the drive gear 23 has the shape of a substantially truncated cone the diameter of which gradually decreases towards a higher position in the vehicle. That is, each tooth of the drive gear 23 is formed such that the diameter of its top is smaller than that of its base.

The first and second belts 24 and 25 are provided in the corresponding guide grooves, 21a to 21d, such that the rack teeth 26 of the belt 24 and the rack teeth 26 of the belt 25 face each other. The first belt 24 is formed such that its first end entering the left guide rail 13b is connected to the left operation mechanism 14 whereas its second end is free within the second guide groove 21b. As for the second belt 25, its first end entering the right guide rail 13a is connected to the right operation mechanism 14 whereas its second end is free within the fourth guide groove 21d.

The movement of the first belt 24 is guided by the first and second guide grooves 21a and 21b. In this case, the movement of the part of the first belt 24 extending from the end of the first guide groove 21a and connected to the operation mechanism 14 is guided by the rail-side guide groove 16 of the left guide rail 13b. On the other hand, the movement of the second belt 25 is guided by the third and fourth guide grooves 21c and 21d. In this case, the movement of the part of the second belt 25 extending from the end of the third guide groove 21c and connected to the operation mechanism 14 is guided by the rail-side guide groove 16 of the right guide rail 13a. Accordingly, the belts 24 and 25 are able to transmit drive force from the electric motor 22 to the corresponding operation mechanisms 14.

Incidentally, the length of each of the belts 24 and 25 and the position of their engagement with the drive gear 23 are adjusted such that when the electric motor 22 is driven, the operation mechanisms 14 move forward and backward within the corresponding guide rails, 13a and 13b, in synchronization with each other. For example, if the drive gear 23 is rotated counterclockwise in FIG. 1, the first belt 24 and second belt 25 enter the left and right guide rails 13a and 13b respectively from the front housing 21. Accordingly, the operation mechanisms 14 synchronously move backward along the corresponding guide rails 13a and 13b. Therefore, the movable panel 15 opens the opening 12 while keeping the widthwise direction of the vehicle horizontal. At this time, the free end of each of the belts 24 and 25 moves toward the drive gear 23. On the other hand, when the drive gear 23 is rotated clockwise in FIG. 1 by driving the electric motor 22, the belts 24 and 25 move from the corresponding guide rails 13a and 13b to the front housing 21. Accordingly, the operation mechanisms 14 synchronously move forward along the corresponding guide rails 13a and 13b. Therefore, the movable panel 15 closes the opening 12 while keeping the widthwise direction of the vehicle horizontal. At the time, the free end of each of the belts 24 and 25 move apart the drive gear 23.

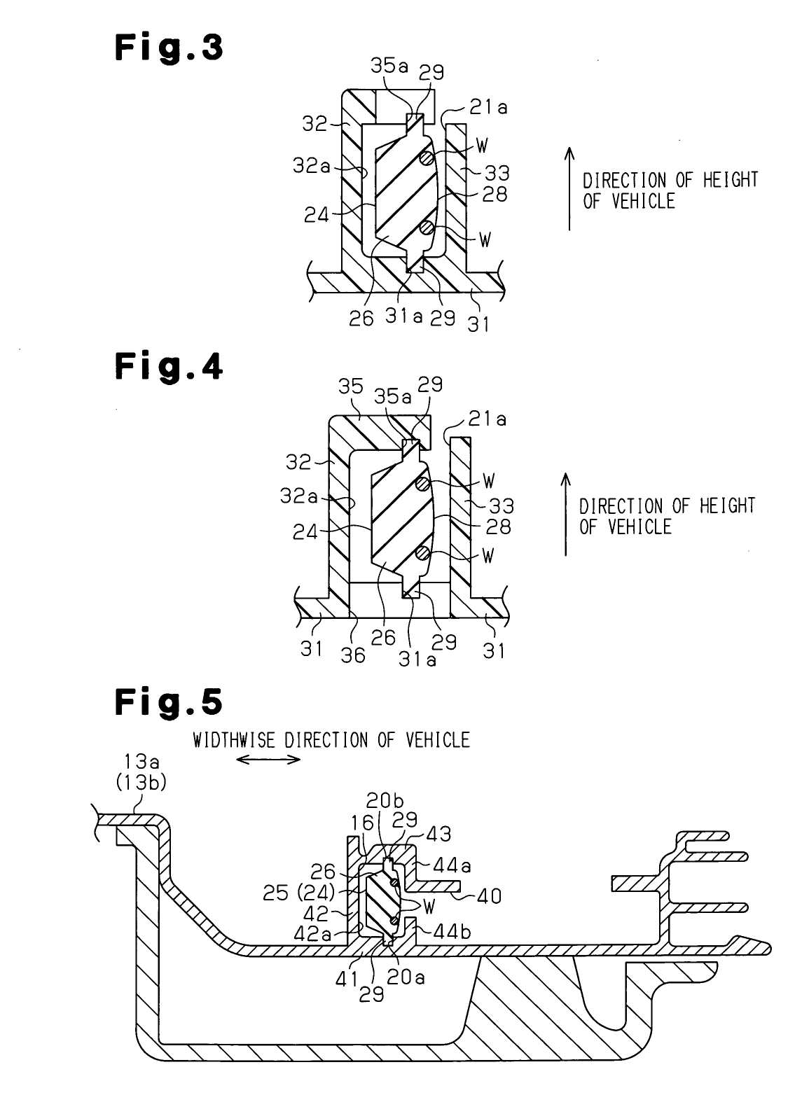

Referring to FIGS. 2 to 6, a belt guide holding structure formed in each of the first to fourth guide grooves 21a to 21d will now be described in detail below. FIG. 2 is an enlarged view of a surrounded part indicated by the reference number 2 in FIG. 1. FIG. 3 is a cross-sectional view taken along the line 3-3 of FIG. 2. FIG. 4 is a cross-sectional view taken along the line 4-4 of FIG. 2. FIG. 5 is a cross-sectional view taken along the line 5-5 of FIG. 1.

As shown in FIG. 1, the front housing 21 has a flat bottom wall 31, which extends over substantially the entire outside shape in a plan view. In addition, as shown in FIG. 2, the front housing 21 integrally has first and second parallel flat sidewalls 32 and 33, which extend from the bottom wall 31 in the direction of the height of the vehicle. The first sidewall 32 has a face 32a opposite the second sidewall 32. This opposite face 32a faces the rack teeth 26 of the first belt 24 accommodated in the first guide groove 21a. The first belt 24 has a rear face 28 opposite the rack teeth 26. This rear face 28 faces the second sidewall 33.

As shown in FIG. 3, at the position the first guide groove 21a, the bottom wall 31 has a drive-side fitting section 31a of substantially quadrangular cross-section open in an upward direction. This fitting section 31a extends over substantially the entire length of the bottom wall 31 in the same direction as the first guide groove 21a.

As shown in FIGS. 2 and 4, flat pressing sections 35 are formed integrally with the first sidewall 32 so as to project from the upper end of the sidewall 32 toward the second sidewall 33. The pressing sections 35 are provided at intervals along the length of the first guide groove 21a. In the pressing section 35, formed on the internal face facing the first belt 24 is a drive-side fitting section 35a of substantially quadrangular cross-section open in a downward direction. The pressing sections 35 suppress upward displacement of the first belt 24 from the first guide groove 21a during movement. Each of the parts of the bottom wall 31 facing the pressing sections 35, has a through hole 36 that is open in the direction of the height of the vehicle; however, each of these parts is not provided with a drive-side fitting section 31a. The fitting sections 31a and 35a correspond to first and second fitting sections respectively. In addition, the holding structure, including the drive-side fitting sections 35a and 31a and pressing sections 35, which is provided for the first guide groove 21a described above is identical in configuration to the other second to fourth guide grooves 21b to 21d. Therefore, explanation thereof is omitted.

As shown in FIG. 5, the rail-side guide groove 16 of the left guide rail 13b extends in the directions of the front and back of the vehicle (i.e., in the direction orthogonal to the sheet of the drawing). The rail-side guide groove 16 is adjacent to a rail 40, which guides movement of the operation mechanism 14, in the widthwise direction of the vehicle. The cross-sectional shape of the rail-side guide groove 16 is substantially identical to the cross-sectional shape of the guide groove 21a described above (refer to FIG. 3). Specifically, the left guide rail 13b includes: a bottom wall 41 adjacent to the rail 40 and extending in the directions of the front and back of the vehicle (i.e., in the direction orthogonal to the sheet of FIG. 5); a sidewall 42 separated from the rail 40 in the widthwise direction of the vehicle and extending in the direction of the height of the vehicle from the edge of the bottom wall 41; and a lid wall 43 extending from the upper end of the sidewall 42 in the widthwise direction of the vehicle so as to be parallel to the bottom wall 41. In addition, the left guide rails 13b include a pair of holding walls 44a and 44b extending from the bottom wall 41 and lid wall 43 respectively in the direction of the height of the vehicle so as to be parallel to each other at the edge adjacent to the rail 40. The sidewall 42 has a face 42a opposite the holding walls 44a and 44b. This opposite face 42a faces the rack teeth 26 of the first belt 24 accommodated in the rail-side guide groove 16. The rail-side guide grooves 16 are defined by these internal wall faces at the bottom wall 41 and the like, so as to have a substantially U-shaped cross-section. The rail-side guide groove 16 is open toward the rail 40 in the widthwise direction of the vehicle. In addition, the bottom wall 41 and lid wall 43 have rail-side fitting sections 20a and 20b respectively on their internal walls facing each other. The openings of the rail-side fitting sections 20a and 20b face each other. In FIG. 5, the right guide rail 13a is symmetrical with the left guide rail 13b, and is identical in configuration to the left guide rail 13b. Therefore, explanation thereof is omitted.

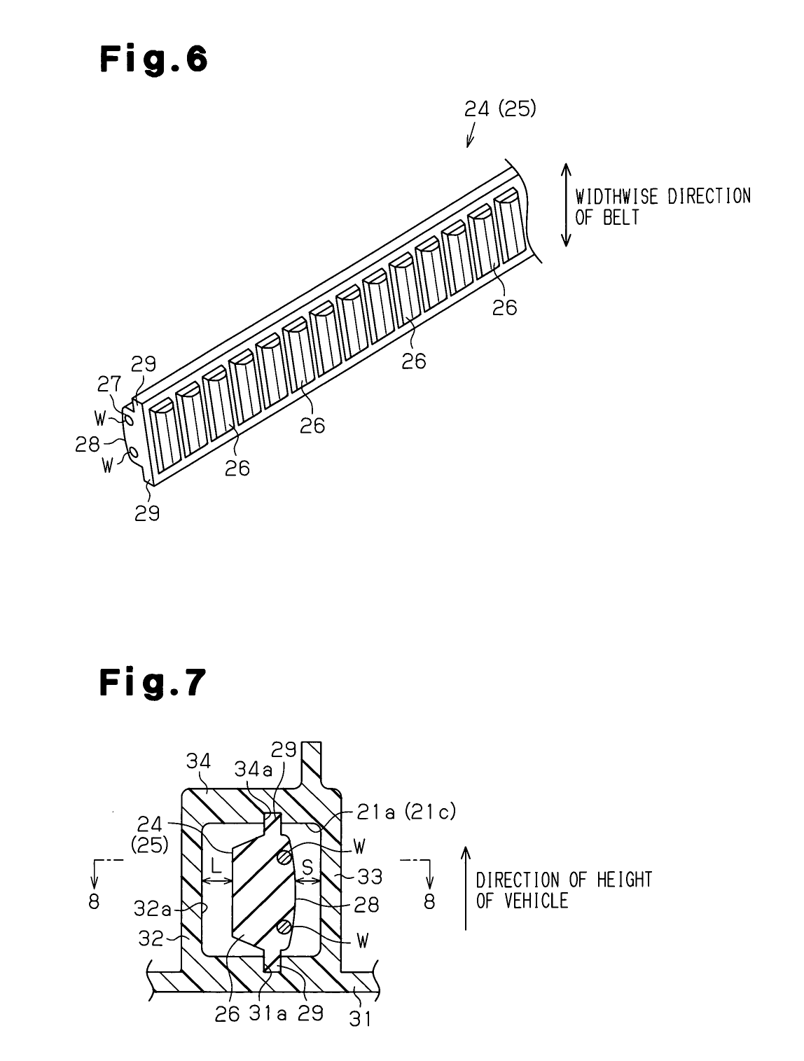

Each of the belts 24 and 25 are accommodated in the corresponding guide grooves 21a to 21d and rail-side guide grooves 16 so as to be movable in such a manner that parts of the belts 24 and 25 along their lengths are surrounded by those corresponding grooves (refer to FIGS. 2 to 5). As shown in FIG. 6, each of the belts 24 and 25 includes a belt section 27 and a plurality of rack teeth 26 arranged at fixed intervals along the length of the belt section 27. In addition, each of the belts 24 and 25 has a pair of sliding sections 29 of substantially quadrangular cross-section such that the sliding sections 29 project from the belt section 27 on both sides in the widthwise direction of the belt section 27. The sliding sections 29 fit in the drive-side fitting sections 31a and 35b, which are formed in the first to fourth guide grooves 21a to 21d so as to be slidable. Therefore, since the sliding sections 29 fit in the drive-side fitting sections 31a and 35a of the corresponding guide grooves 21a to 21d, each of the belts 24 and 25 move along the guide grooves 21a to 21d while movement (i.e., displacement) is restricted in the direction in which the first and second sidewalls 32 and 33 face each other (in particular, in the direction in which the rack teeth 26 approach the opposite face 32a of the first sidewall 32).

Similarly, the sliding sections 29 respectively fit in the rail-side fitting sections 20a and 20b formed in the rail-side guide grooves 16 so as to be slidable. Therefore, since the sliding sections 29 fit in the rail-side fitting sections 20a and 20b of the corresponding rail-side guide grooves 16, each of the belt 24 and 25 move along the rail-side guide grooves 16 while movement (i.e., displacement) is restricted in the direction where the sidewall 42 faces hold the walls 44a and 44b (in particular, in the direction in which the rack teeth 26 approach the opposite face 42a of the sidewall 42). A plurality of metal wires W (in this embodiment, two) are embedded in each of the belt 24 and 25 so as to extend along a length of each of the belt 24 and 25. Accordingly, the belts 24 and 25 have required strength while ensuring deformable flexibility.

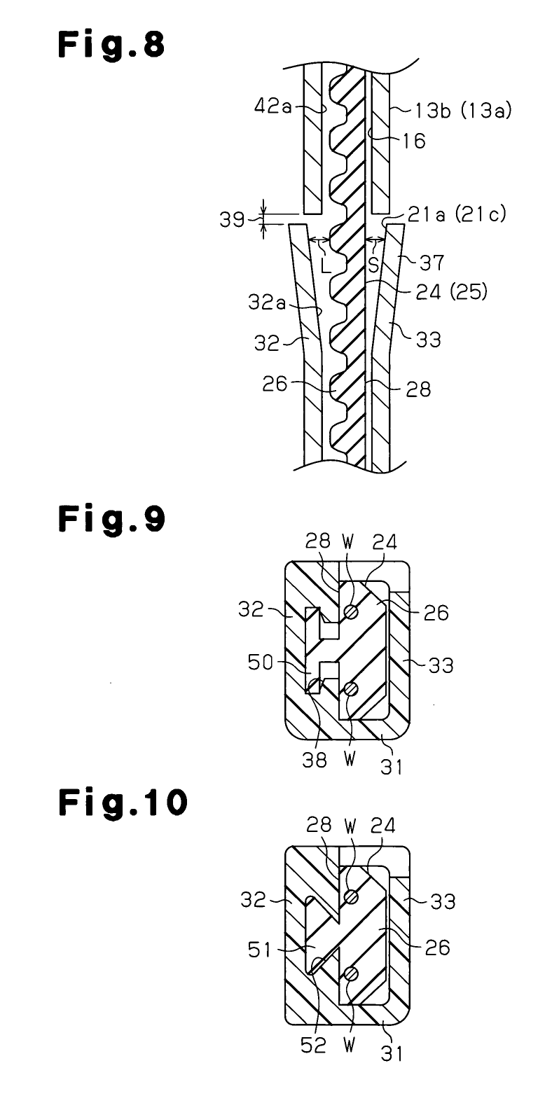

Referring to FIGS. 7 and 8, a transfer structure will next be described for the first belt 24 at the boundary between the first guide groove 21a and the rail-side guide groove 16 of the left guide rail 13b. FIG. 7 is a cross-sectional view taken along the line 7-7 of FIG. 1. FIG. 8 is a cross-sectional view taken along the line 8-8 of FIG. 7.

As shown in FIG. 7, formed in the rear end portion (i.e., the connection portion) of the first guide groove 21a connected to the left guide rail 13b is a lid 34, which covers the first belt 24 all around, together with the sidewalls 32 and 33 and the bottom wall 31. Formed in the lid 34 is a drive-side fitting section 34a, to which the upper sliding section 29 fits so as to be slidable. The drive-side fitting section 34a is identical in shape to the above-mentioned drive-side fitting section 35a provided for the pressing section 35. The drive-side fitting section 34a restricts the first belt 24 from moving (i.e., being displaced) together with the drive-side fitting section 31a in vertical or horizontal directions, in particular, in the direction in which the first and second sidewalls 32 and 33 face (i.e., in particular, in the direction where the rack teeth 26 approach the opposite face 32a of the first sidewall 32). Needless to say, these drive-side fitting sections 31a and 34a are connected to the rail-side fitting sections 20a and 20b of the left guide rail 13b in the directions of the front and back of the vehicle. Therefore, the first belt 24 guided by the first guide groove 21a and the rail-side guide groove 16 of the left guide rail 13b is securely transferred between the front housing 21 and the guide rail 13b.

Additionally, as shown in FIG. 8, formed in the rear end portion (connection portion) of the first guide groove 21a is an inclined part 37, which curves away from the first belt 24 as the inclined part 37 approaches the left guide rail 13b in the direction of the thickness of the first belt 24. That is, clearance L between the rack teeth 26 of the first belt 24 and the opposite face 32a of the first sidewall 32 and clearance S between the rear face 28 of the first belt 24 and the internal face of the second sidewall 33 gradually increase as the inclined part 37 approaches the end of the left guide rail 13b. The inclined part 37 is formed integrally with the first guide groove 21a so as to be line-symmetrical with respect to the axis of the first belt 24 in the direction in which the belt 24 extends. Incidentally, the drive-side fitting sections 31a and 34a are disposed so as to correspond to the end of the first guide groove 21a defining the maximum clearances L and S. Accordingly, the above-described movement (i.e., displacement) of the first belt 24 is restricted. In addition, the end of the first guide groove 21a and the end of the left guide rail 13b face each other with a slight gap 39 between them.

In order to smoothly transfer the first belt 24 between the first groove 21a and the rail-side guide groove 16 of the left guide rail 13b, the first guide groove 21a and the rail-side fitting sections 20a and 20b of the left guide rail 13b need to be accurately aligned with the directions of the front and back of the vehicle. However, the front housing 21 is made of resin, making it difficult to ensure precision in shape. Therefore, when the first guide groove 21a is connected with the rail-side guide groove 16, a step is highly likely to be formed between the opposite faces 42a and 32a due to assembly error or variations in manufacture therebetween. Such a problem occurs even in the same materials. Due to this step between the opposite faces 42a and 32a, the first belt 24 may move (i.e., be displaced) in the direction of its thickness near the gap 39 between the first guide groove 21a and the rail-side guide groove 16. However, even in such a case, a clearance L is ensured between the first belt 24 and the opposite face 32a, thus preventing the rack teeth 26 of the first belt 24 from contacting the opposite face 32a. Accordingly, noise can be reduced. The transfer structure described above is identical to that between the third guide groove 21c and the rail side guide groove 16 of the right guide rail 13a. Therefore, explanation thereof is omitted.

In the foregoing configuration, when the drive gear 23 is rotated by driving the electric motor 22, the first belt 24 and the second belt 25 move along the first to fourth guide grooves 21a to 21d (accurately, drive-side fitting section 31a and the like). Accordingly, the first belt 24 is restricted from moving in the direction of its thickness. Especially, the rack teeth 26 are prevented from contacting the first sidewall 32. As described above, each of the guide grooves 21a to 21d is provided with the pressing sections 35, disposed at intervals, and the lids 34. The upper sliding sections 29 of the belts 24 and 25 are fitted in the drive-side fitting sections 35a and 34a of the pressing section and the lid portion 34 respectively. Thus, upward movement of the belts 24 and 25 relative to the corresponding guide grooves 21a to 21d is prevented. In addition, as described above, even if the belts 24 and 25 are moved in their respective thickness directions due to steps between the first and third guide grooves 21a and 21c and the rail-side guide groove 16 due to assembly error or suchlike, the clearance L is ensured between each of the belt 24 and 25, and the first sidewall 32. Accordingly, each of the belts 24 and 25, and especially the rack teeth 26 are prevented from contacting the first sidewall 32. This makes it possible to reduce vibration, noise, and the like during movement of the belts 24 and 25.

The present embodiment has the advantages described below.

(1) A pair of sliding sections 29 of each of the belts 24 and 25 fit in corresponding drive-side fitting sections 31a, 35a, and 34a or rail-side fitting sections 20a and 20b so as to be slidable. This restricts movement of the rack teeth 26 of each of the belt 24 and 25 toward the opposite face 42a of the guide groove 16 and the opposite face 32a of each of guide grooves 21a to 21d. This makes it possible always to ensure that there is a clearance between the rack teeth 26 and the opposite faces 42a and 32a during movement of each of the belt 24 and 25. Therefore, even if a step (e.g., a mold joints) is formed between the opposite faces 42a and 32a during the molding of, for example, sidewalls 42 and 32, or if a notch is formed in the opposite faces 42a and 32a, rack teeth 26 are prevented from contacting these steps or the like during movement of the belts 24 and 25. In addition, when the belts 24 and 25 enter the corresponding rail-side guide grooves 16 from the corresponding first to fourth guide grooves 21a to 21d, or when the belts 24 and 25 enter the corresponding first to fourth guide grooves 21a to 21d from the corresponding rail-side guide grooves 16, each of the sidewall 42 and 32 and the rack teeth 26 are prevented from contacting each other at the end of the corresponding rail-side guide grooves 16 or at each of the first to fourth guide grooves 21a to 21d. Hence, noise and vibration thus resulting can be reduced.

(2) In the belts 24 and 25, movement of the rack teeth 26 toward the opposite face 42a in the groove 16 and the opposite face 32a in each of 21a to 21d is restricted. Thus, the required clearance can be ensured between the rack teeth 26 and the opposite face 42a of each guide groove 16 and the opposite face 32a of each of the guide grooves 21a to 21d. Accordingly, even if a step forms between the opposite faces 42a and 32a at the boundary between each of the first to fourth guide grooves 21a to 21d and the corresponding rail-side guide grooves 16 due to, for example, variations in manufacture or assembly error, the step is absorbed in the range of the clearance. This makes it possible to prevent the rack teeth 26 from contacting each other during movement of each of the belts 24 and 25. Hence noise and vibration due to the contact can be reduced.

(3) The inclined part 37 extends such that the clearance L between the opposite face 32a and the rack teeth 26 gradually increases toward the ends of the first and third guide grooves 21a and 21c. Therefore, when the belts 24 and 25 enter the first guide groove 21a or the third guide groove 21c respectively from the corresponding rail-side guide groove 16, contact between the sidewall 32 and rack teeth 26 at these ends is more reliably prevented. In addition, even if assembly error between the first guide groove 21a and rail-side guide groove 16 or variations in manufacture occur, the clearance L prevents contact between the sidewall 32 and the rack teeth 26, thus facilitating precision of management of the alignment of the first guide groove 21a and the rail-side guide groove 16 to each other.

(4) In each of the belts 24 and 25, the pair of sliding sections 29 formed on both sides of the belt in the widthwise direction of the belt fit in the drive-side fitting sections 31a and 35a or in the rail-side fitting sections 20a and 20b. This enables the belts 24 and 25, unconstrained by the shapes of the opposite faces 42a and 32a of the first to fourth guide grooves 21a to 21d or rail-side guide grooves 16 to the rack teeth 26, to move more stably. In particular, in the area where the inclined part 37 is formed, as in other areas, movement of the belts 24 and 25 can be guided by virtue of the drive-side fitting sections 31a and 35a.

(5) Each tooth of the drive gear 23 has the shape of a substantially truncated cone the diameter of which is smaller towards the top than towards the base. That is, the outside diameter of each tooth of the drive gear 23 gradually decreases towards the lower part from the higher part. Accordingly, each of the belts 24 and 25 can engage with the drive gear 23 such that the gap between them is always minimal.

The above embodiments may be modified as follows.

In the foregoing embodiment, the sliding sections 29 on both sides of the belt section 27 are in the direction of its width. However, the position and shape of the sliding sections 29 are not limited thereto. For example, as shown in FIG. 9, a sliding section 50 with a substantially T-shaped cross-section may be formed in the rear face 28 of the first belt 24 so as to extend along the length of the first belt 24. In this case, a fitting groove 38 with a substantially T-shaped cross-section that fits on the sliding section 50 is formed in the first sidewall 32 along the path of each of the guide grooves 21a to 21d. In addition, as shown in FIG. 10, a sliding section 51 with a substantially trapezoidal cross-section may be formed in the rear face 28 of the first belt 24 so as to extend along the length of the first belt 24. In this case, a fitting groove 52 with a substantially trapezoidal cross-section that fits on the sliding section 29 is formed in the first sidewall 32 along the path of each of the guide grooves 21a to 21d. This configuration enables the first belt 24 to be moved lengthways (i.e., in the direction of the sheet of the drawing of FIGS. 9 and 10) while vertical or horizontal movement of the first belt 24 is restricted. For smooth transfer of the first belt 24 in the configuration in which a sliding section 29 is provided on the rear face 28 of the first belt 24 as described above, the inclined part 37 facing the rear face 28 of the first belt 24 should be omitted.

In the foregoing embodiment, the guide rails 13a and 13b are formed of aluminum, and the front housing 21 having the first to fourth guide grooves 21a and 21d is formed of resin. However, the materials for the guide rails 13a and 13b and the front housing 21 are not limited thereto. For example, all of them may be resin or metal.

In the foregoing embodiment, the inclined parts 37 are formed in the thickness directions of the belts 24 and 25. However, each of these inclined parts 37 may be formed only at the point where at least each of the belt 24 and 25 faces the rack teeth 26, and the inclined part 37 facing each rear face 28 may be omitted.

In the foregoing embodiment, a rib for reinforcing the guide grooves 21a to 21d and the like may be formed integrally on the front housing 21 (bottom wall 31).

The foregoing embodiment may adopt a front housing divided into two on both sides of the drive gear 23 in the widthwise direction of the vehicle.

In the foregoing embodiment, through holes 36 may be omitted.

In the foregoing embodiment, the belts 24 and 25 are held by the guide grooves 21a and 21d. However, the embodiment is not limited thereto. A type in which each of the belts 24 and 25 is held in a casing pipe may also be applied in the present invention. Specifically, noise and the like, which may be caused by contact between the belts 24 and 25, and the casing pipe, can be decreased by providing the inside of the casing pipe with fitting sections 31a and 35a or by providing the guide rails 13a and 13b with the inclined parts 37.

### DESCRIPTION OF THE REFERENCE NUMERALS

11 Roof
12 Opening
13a Right Guide Rail
13b Left Guide Rail
14 Operation Mechanism
15 Movable Panel
16 Rail-side Guide Groove
21 Front Housing (Housing)
20a, 20b Rail-side Fitting Section
21a-21d First to Fourth Guide Grooves (Guide Sections)
22 Electric Motor (Drive Source)
23 Drive Gear
24 First Belt
25 Second Belt
26 Rack Teeth
27 Rear Face
29, 50, 51 Slide portions
31 Bottom Wall
31a, 34a, 35a Drive-side Fitting Sections
32 First Sidewall
33 Second Sidewall
35 Pressing Section
35a Drive-Side Fitting Section
36 Through Hole

1. A roof device for a vehicle, the roof device comprising:
a movable panel capable of opening and closing an opening provided in a vehicle roof;
a pair of guide rails on both sides of the opening in a widthwise direction of the vehicle, the guide rails being adapted to extend in a direction along the front and back of the vehicle;
an operation mechanism guided by the corresponding guide rail and supporting the movable panel;
a drive gear rotated and driven by a drive source;
a toothed belt configured to engage with the drive gear and connected to the corresponding operation mechanism, wherein the toothed belt has a plurality of rack teeth arranged in a longitudinal direction of the toothed belt;
a drive-side guide section extending between the drive gear and each guide rail so as to surround the corresponding toothed belt and configured to guide movement of the toothed belt;
a rail-side guide section formed in each guide rail, extending toward the operation mechanism so as to surround the toothed belt, and configured to guide movement of the toothed belt;
a sliding section formed integrally with each toothed belt; and
a fitting section formed in at least each drive-side guide section or each rail-side guide section and slidably fitting on the corresponding sliding section, wherein the fitting section restricts movement of the rack teeth of each toothed belt toward the corresponding opposite face of the drive-side guide section or the rail-side guide section.

2. The roof device for a vehicle according to the claim 1, wherein the fitting section includes a drive-side fitting section formed in each drive-side guide section and a rail-side fitting section formed in the rail-side guide section.

3. The roof device for a vehicle according to claim 2, wherein the end of the drive-side guide section connected to the corresponding rail-side guide section has an inclined part that gradually increases a clearance between the opposite face and the rack teeth as the inclined part approaches the rail-side guide section.

4. The roof device for a vehicle according to claim 1, wherein:
the sliding sections are formed on both sides of each toothed belt in a widthwise direction of the toothed belt and extend in the longitudinal direction of the toothed belt; and
the fitting section includes a first fitting section and second fitting section arranged so as to face the corresponding sliding sections of each toothed belt.
